(19) United States
(12) Patent Application Publication
(10) Pub. No.: US 2017/0102604 A1
(43) Pub. Date: Apr. 13, 2017

(54) Dual-Wavelength Optical Parametric Oscillator

(71) Applicants: Fundacio Institut De Ciencies Fotoniques (ICFO), Barcelona (SE); Institucio Catalana De Recerca I Estudis Avancats (ICREA), Barcelona (ES)

(72) Inventors: Majid Ebrahim-Zadeh, Barcelona (ES); Suddappali Chaitanya Kumar, Barcelona (ES)

(21) Appl. No.: 15/129,479

(22) PCT Filed: Mar. 27, 2015
(86) PCT No.: PCT/EP2015/056811

§ 371 Date: Sep. 27, 2016

(30) Foreign Application Priority Data
Mar. 27, 2014 (GB) 1405555.2

(51) Int. Cl. G02F 1/39

(52) U.S. Cl. CPC G02F 1/39; H01S 3/0092

(57) ABSTRACT

An optical parametric oscillator (3) is configured to provide first ultrashort output pulses comprising light of a first wavelength and second ultrashort output pulses comprising light of a second wavelength, wherein at least one of the first and second wavelengths is independently controllable. The optical parametric oscillator (3) comprises an optical resonator (10) containing first and second nonlinear optical elements (11, 12) and comprising an output coupler (13), an input system (14) configured to provide first pump pulses to the first nonlinear optical element (11) and second pump pulses to the second nonlinear optical element (12), and a control system (15).

### FIELD

The present invention relates to an optical parametric oscillator, particularly an optical parametric oscillator configured to provide first ultrashort output pulses comprising light of a first wavelength, and second ultrashort output pulses comprising light of a second wavelength, wherein at least one of the first and second wavelengths is independently controllable.

### BACKGROUND

Optical parametric oscillators, which convert input laser light beams with a frequency ωₚ into two (signal and idler) output laser light beams of lower frequency (ωₛ,ωᵢ) by means of a second-order nonlinear optical interaction, are well known. The sum of the output beams' frequencies is equal to the input beam's frequency, i.e. ωₛ+ωᵢ=ωₚ.

### SUMMARY

According to a first aspect of the present invention, there is provided an optical parametric oscillator configured to provide first ultrashort output pulses comprising light of a first wavelength and second ultrashort output pulses comprising light of a second wavelength, wherein at least one of the first and second wavelengths is independently controllable, the optical parametric oscillator comprising:
an optical resonator containing first and second nonlinear optical elements and comprising an output coupler;
an input system configured to provide first pump pulses to the first nonlinear optical element and second pump pulses to the second nonlinear optical element; and
a control system;
wherein the first nonlinear optical element is configured to provide first signal pulses and first idler pulses in response to the first pump pulses, the first signal pulses or the first idler pulses corresponding to first resonant pulses and comprising light of the first wavelength;
wherein the second nonlinear optical element is configured to provide second signal pulses and second idler pulses in response to the second pump pulses, the second signal pulses or the second idler pulses corresponding to second resonant pulses and comprising light of the second wavelength;
wherein the output coupler is configured to couple light from the first resonant pulses to the first output pulses and light from the second resonant pulses to the second output pulses;
wherein the control system is configured to control a property of the first nonlinear optical element to control the first wavelength and/or configured to control a property of the second nonlinear optical element to control the second wavelength; and
wherein the optical parametric oscillator is configured to substantially or completely avoid coherent coupling between the first and second resonant pulses for all first wavelengths in a first range and all second wavelengths in a second range which overlaps with the first range.

Thus, two sets of output pulses comprising light of two independently and arbitrarily controllable wavelengths can be provided, which is particularly useful in several applications including, for example, nonlinear vibrational spectroscopy/microscopy. Furthermore, because the two sets of output pulses are provided by a single cavity, they can have more uniform properties compared, for example, with an arrangement including two optical parametric oscillators.

Optional features are specified in the dependent claims.

### BRIEF DESCRIPTION OF THE DRAWINGS

Certain embodiments of the present invention will now be described, by way of example only, with reference to the accompanying drawings in which:

FIG. 1(a) illustrates apparatus configured to perform spectroscopy/microscopy.

FIG. 1(b) illustrates an optical parametric oscillator included in the apparatus of FIG. 1(b).

FIG. 2 shows wavelength spectra of first output pulses and wavelength spectra of second output pulses as the temperature of a first nonlinear optical element in the optical parametric oscillator is changed and the temperature of a second nonlinear optical element in the optical parametric oscillator is held constant.

FIG. 3(a) shows the powers of first and second output pulses as their wavelengths are varied and as the pump power is held constant.

FIG. 3(b) shows the change in the wavelengths of first and second output pulses as the temperature of the first and second nonlinear optical elements, respectively, are varied. The experimental conditions correspond to those in FIG. 3(a).

FIG. 4(a) shows the powers of first and second signal output pulses scaling as a function of the pump power at a constant temperature.

FIG. 4(b) shows the powers of first and second idler output pulses scaling as a function of the pump power. The experimental conditions correspond to those in FIG. 4(a).

FIG. 5(a) shows the stability of the power of first signal output pulses over an extended period of time.

FIG. 5(b) shows the stability of the power of second signal output pulses over an extended period of time.

FIG. 5(c) shows the spatial beam profile of first signal output pulses. The experimental conditions correspond to those in FIG. 5(a).

FIG. 5(d) shows the spatial beam profile of second signal output pulses. The experimental conditions correspond to those in FIG. 5(b).

FIG. 6(a) shows the temporal and spectral characteristics of first signal output pulses.

FIG. 6(b) shows the temporal and spectral characteristics of second signal output pulses.

FIG. 7 shows the timing of sets of first and second signal output pulses.

### DETAILED DESCRIPTION OF THE CERTAIN EMBODIMENTS

Apparatus

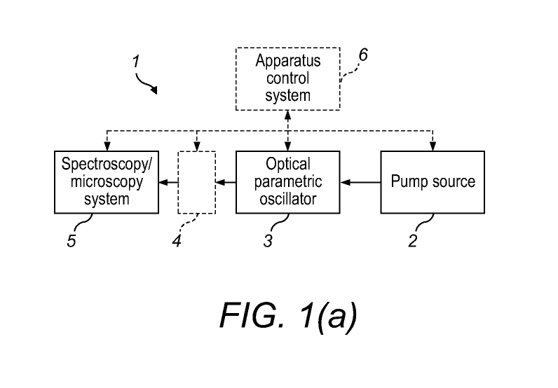

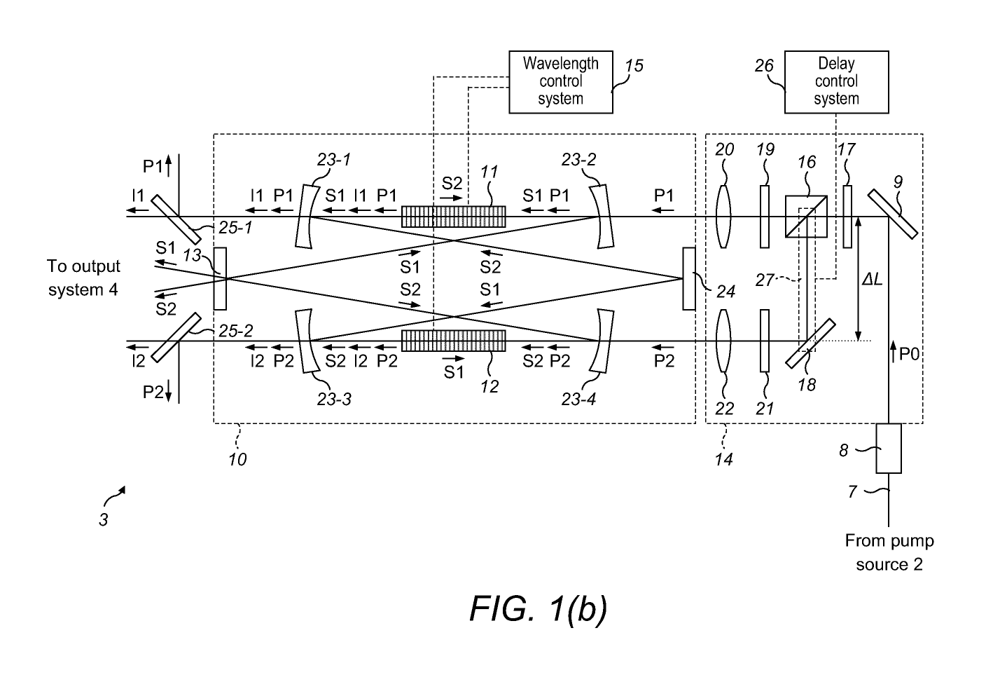

Referring to FIG. 1(a), apparatus 1 for performing spectroscopy/microscopy will now be described. The apparatus 1 includes a pump source 2, an optical parametric oscillator 3 operatively connected to the pump source 2, an optional output system 4 operatively connected to the optical parametric oscillator 3, and a spectroscopy/microscopy system 5 operatively connected to output system 4 or, in examples in which this is not present, to the optical parametric oscillator 3. The apparatus 1 also preferably includes a control system 6 (hereinafter referred to as the apparatus control system) operatively connected to at least one of the pump source 2, the optical parametric oscillator 3, the output system 4 and the spectroscopy/microscopy system 5.

As will be explained in more detail below, the pump source 2 is configured to provide ultrashort pulses of light (e.g. pulses of light having a duration of more than 1 picosecond and/or less than 1 nanosecond) to the optical parametric oscillator 3. The optical parametric oscillator 3 is configured to provide a first set of (“first”) ultrashort output pulses including light of a first wavelength (e.g. having a centre wavelength corresponding to a first wavelength), and a second set of (“second”) ultrashort output pulses including light of a second wavelength (e.g. having a centre wavelength corresponding to a second wavelength), wherein at least one of the first and second wavelengths is independently controllable. The spectroscopy/microscopy system 5 may correspond, for example, to a coherent anti-Stokes Raman scattering (CARS)-spectroscopy/microscopy system 5, and may use the first signal pulses as pump pulses and the second signal pulses as Stokes pulses.

Pump Source

In this example, the pump source 2 includes a mode-locked ytterbium-fibre laser. In other examples, the pump source 2 may include a different type of laser, for example another type of mode-locked fibre laser, a mode-locked crystalline solid-state laser or a mode-locked semiconductor laser. In this example, the pulses provided by the pump source 2 (hereinafter referred to as initial pump pulses) include light of a wavelength of 1064 nanometres, have a pulse width of 20 picoseconds, a repetition rate of 80 megahertz, and a maximum average power (over one or more repetition periods) of 20 watts. In other examples, the initial pump pulses may have one or more different parameters. The wavelength of light in the initial pump pulses can be changed to change the wavelengths of the light in the other pulses in the apparatus 1 and hence the ranges in which the first and second wavelengths can be controlled.

The repetition rate may correspond to any value between 1 megahertz and 10 gigahertz. One or more parameters of the initial pump pulses may be controllable, for example under control of the apparatus control system 6.

The pump source 2 is connected to the optical parametric oscillator 3 via a fibre 7 (FIG. 1(b)). A Faraday isolator 8 (FIG. 1(b)) is preferably at the output end of the fibre 7 (FIG. 1(b)) to protect the pump source 2 from any back reflections.

Optical Parametric Oscillator

Referring to FIG. 1(b), the optical parametric oscillator 3 (hereinafter referred to merely as an oscillator) will now be described in more detail.

The oscillator 3 includes a single optical resonator 10 containing two nonlinear optical elements, i.e. first and second nonlinear optical elements 11, 12. The optical resonator 10 (hereinafter referred to as the cavity) includes an output coupler 13. The oscillator 3 also includes an input system 14 and a control system 15 (hereinafter referred to as the wavelength control system). Each of these elements will be described in more detail below.

—Input System—

The input system 14 is configured to receive the initial pump pulses originating from the pump source 2 and to provide pump pulses (hereinafter referred to as first pump pulses) to the first nonlinear optical element 11 and pump pulses (hereinafter referred to as second pump pulses) to the second nonlinear optical element 12. In the figure, the initial, first and second pump pulses are denoted by P0, P1 and P2, respectively.

The input system 14 preferably includes a dividing element 16 configured to provide a first pump pulse and a second pump pulse in response to each initial pump pulse. In this example, the dividing element 16 corresponds to a polarising beam splitter 16. However, in other examples, there may be different means for producing the first and second pump pulses such as, for example, a coated optical element or a partially transmitting/reflecting mirror beam-splitter.

The input system 14 is preferably configured to provide the first pump pulses to the first nonlinear optical element 11 and the second pump pulses to the second nonlinear optical element 12 at different times.

In this example, the input system 14 is configured to delay the second pump pulses provided by the dividing element 16. In other examples, the input system 14 may be configured to delay the first pump pulses provided by the dividing element 16.

The input system 14 is configured such that a beam originating from the pump source 2 (hereinafter referred to as the initial pump beam) is preferably reflected by a mirror 9 (hereinafter referred to as the first mirror) and then propagates through an initial half-wave plate 17 and then the polarising beam splitter 16. The polarising beam splitter 16 is configured to split the initial pump beam into two beams (hereinafter referred to as first and second pump beams). The first and second pump beams preferably propagate in perpendicular directions. However, these directions may be non-perpendicular. The second pump beam is then reflected by a mirror 18 (hereinafter referred to as the second mirror) and propagates in a direction that is preferably parallel to the first pump beam. However, this direction may be non-parallel to the first pump beam. The first pump beam propagates through a first half-wave plate 19 and then a first lens 20. The second pump beam, after being reflected by the second mirror 18, propagates through a second half-wave plate 21 and then a second lens 22. The first and second half-wave plates 19, 21 are configured to provide beams with suitable polarization for phase-matching in the first and second nonlinear optical elements 11, 12, respectively. The first and second lenses 20, 22 are preferably configured to provide beams focused at the centre of the first and second nonlinear optical elements 11, 12, respectively, for example to a beam waist radius of ωₒ₁≈ωₒ₂≈65 micrometres, corresponding to a confocal focusing parameter of ξ₁≈ξ₂≈0.93.

The path from the dividing element 16 to the second nonlinear optical element 12 is longer than the path from the dividing element 16 to the first nonlinear optical element 11. Accordingly, the second pump pulses travel an additional path length relative to the first pump pulses. The additional path length functions as a delay line 28 for the second pump pulses. For example, an additional path length of ΔL≈42 centimetres corresponds to a delay of ˜1.4 nanoseconds. In this example, the additional path length corresponds to the separation between the polarising beam splitter 16 and the second mirror 18. In other examples, any element or combination of elements that produces a difference between the total optical path lengths for two sets of pulses from the output of the pump source 2 to the respective nonlinear optical elements 11, 12 will serve the same function.

The input system 14 is preferably configured to controllably delay the second pump pulses such that a time offset between the first and second output pulses is controllable. The delay may be controlled by a delay control system 26. The delay control system 26 may operate under control of the apparatus control system 6.

For example, the optical path length of the delay line 27 may be controllably changed, e.g. by moving the second mirror 18. In this instance, the input system 14 preferably includes additional optical elements (not shown) to maintain the position and angle of incidence of the second pump beam on the second nonlinear optical element 12.

Time offsets from zero up to about 1 microsecond can be achieved.

In some examples, two pump sources may be used and the distance between the pump sources and the respective nonlinear optical elements 11, 12 may be controlled. However, such an approach can be less cost-efficient and/or less effective.

—Nonlinear Optical Elements—

The first nonlinear optical element 11 is configured to provide signal and idler pulses (hereinafter referred to as first signal pulses and first idler pulses, respectively) in response to the first pump pulses. The second nonlinear optical element 12 is configured to provide signal and idler pulses (hereinafter referred to as second signal pulses and second idler pulses, respectively) in response to the second pump pulses. In the figure, the first and second signal pulses and the first and second idler pulses are denoted by S1, S2, I1 and 12, respectively.

In this example, each of the first and second nonlinear optical elements 11, 12 corresponds to a magnesium oxide doped periodically-poled lithium niobate (MgO:PPLN) crystal. In other examples, one or both of the nonlinear optical elements 11, 12 may correspond to a different type of crystal. For example one or both of the nonlinear optical elements 11, 12 may correspond to a different type of periodically-poled crystal. One or both of the nonlinear optical elements 11, 12 may correspond to a birefringent crystal. One or both of the nonlinear optical elements 11, 12 may be formed from magnesium oxide-doped periodically-poled stoichiometric lithium tantalite (MgO:sPPLT), periodically-poled potassium titanyl phosphate (PPKTP), periodically-poled potassium titanyl arsenate (PPKTA), periodically-poled rubidium titanyl arsenate (PPRTA), periodically-poled rubidium titanyl phosphate (PPRTP), lithium triborate, cadmium silicon phosphide (CdSiP₂, CSP), zinc germanium phosphide (ZnGeP₂, ZGP), or orientation-patterned gallium arsenide (OP-GaAs).

The properties of the first and second nonlinear optical elements 11, 12 can be changed to change the wavelengths of the light in the other pulses in the apparatus 1, and hence the ranges in which the first and second wavelengths can be controlled.

In this example, the first nonlinear optical element 11 is 48-mm-long, and the second nonlinear optical element 12 is 50-mm-long. In other examples, one or both of the nonlinear optical elements 11, 12 may have different lengths from these lengths.

Both of the nonlinear optical elements 11, 12 preferably have a grating with a period that varies in a direction perpendicular to the path of the pump pulses. In this example, both of the nonlinear optical elements 11, 12 have fan-out gratings, with grating periods varying from Λ=28.5 to 31.5 micrometres in steps of 0.5 micrometres. In other examples, one or both of the nonlinear optical elements 11, 12 may have a grating with a grating period that varies in a different way. One or both of the nonlinear optical elements 11, 12 may have a grating with a constant grating period.

The combination of the first nonlinear optical element 11 and the other elements of the oscillator 3 is hereinafter referred to as the first oscillator subsystem 3a. The combination of the second nonlinear optical element 12 and the other elements of the oscillator 3 is hereinafter referred to as the second oscillator subsystem 3b.

—Cavity and Output Coupler—

The cavity 10 is configured to resonate either the first signal pulses or the first idler pulses, and resonate either the second signal pulses or the second idler pulses. The resonated ones of the first signal pulses or the first idler pulses are hereinafter referred to as first resonant pulses, while the other ones are hereinafter referred to as first non-resonant pulses. The resonated ones of the second signal pulses or the second idler pulses are hereinafter referred to as second resonant pulses, while the other ones are hereinafter referred to as second non-resonant pulses. In this example, the first and second resonant pulses are the first and second signal pulses, respectively. In other examples, one or both of the resonant pulses may be idler pulses.

In this example, the cavity 10 corresponds to a folded ring cavity. The cavity 10 is formed using four plano-concave mirrors 23-1, 23-2, 23-3, 23-4, a plane mirror 24 and a conventional plane output coupler 13.

The mirrors 23-1, 23-2, 23-3, 23-4, 24 are preferably highly reflecting for at least the range of first and second wavelengths that the oscillator 3 is configured to provide. In this example, the mirrors 23-1, 23-2, 23-3, 23-4, 24 have a reflectivity R>99% for wavelengths between 1.3 and 2.2 micrometres. The mirrors 23-1, 23-2, 23-3, 23-4, 24 are also preferably highly transmitting for at least the wavelength of the pump pulses and for at least the range of wavelengths of the non-resonant pulses that the oscillator 3 is configured to provide. In this example, the mirrors 23-1, 23-2, 23-3, 23-4, 24 has a transmittance T>90% at 1064 nanometres and a transmittance T>87% for wavelengths between 2.2 and 4 micrometres.

The output coupler 13 is configured to couple light from the first resonant pulses to the first output pulses and light from the second resonant pulses to the second output pulses.

The output coupler 13 preferably provides partial transmission for at least the range of first and second wavelengths that the oscillator 3 is configured to provide. In this example, the output coupler 13 has a transmittance T≈20% for wavelengths between 1100 and 1630 nanometres.

The oscillator 3 may also include a first dichroic mirror 25-1 outside the cavity 10 aligned with the path along which the first pump pulses are provided to the first nonlinear optical element 11. The oscillator 3 may also include a second dichroic mirror 25-2 outside the cavity 10 aligned with the path along which the second pump pulses are provided to the second nonlinear optical element 12. The dichroic mirrors 25-1, 25-2 are configured to separate the non-resonant pulses which exit the cavity 10 in this direction from the pump pulses which exit the cavity 10 in this direction. These pulses may then be used as appropriate.

In this example, the oscillator 3 is configured such that first and second resonant pulses propagate in opposite directions around the optical resonator.

To achieve this, the input system 14 is configured to provide the first pump pulses such that the first pump pulses propagate along a part of a path around the optical resonator in a first direction relative to the path, and configured to provide the second pump pulses such that the second pump pulses propagate along a part of the path around the optical resonator in a second, opposite direction relative to the path. In the example illustrated in FIG. 1(b), the first and second pump pulses are provided in the same direction to different legs of the cavity 10. Other examples may have a different configuration. For example, the first and second pump pulses may be provided in opposite directions to the same leg of the cavity 10.

In this example, the first and second output pulses provided by the output coupler 13 propagate in different directions. This can facilitate separate use of the first and second output pulses.

In other examples, the oscillator 3 may be configured such that first and second resonant pulses propagate in the same direction around the cavity 10, and the first and second output pulses propagate in the same direction along a common optical path.

The cavity 10 has a total optical length that defines the same round-trip frequency for the first and second pump pulses. The repetition frequency of the pump pulses preferably corresponds to (i.e. equals or is a factor of or a multiple of) the round-trip frequency, such that the first and second nonlinear optical elements 11, 12 are synchronously pumped. In this example, the total optical length of the cavity 10 is ˜186 centimetres, corresponding to a round-trip frequency of ˜160 megahertz.

In other examples, the folded ring cavity 10 may be differently configured, for example with fewer or more mirrors and/or legs. The cavity 10 may correspond to a different type of cavity, for example a folded standing-wave cavity.

—Wavelength Control System—

The wavelength control system 15 is preferably configured to control a property of the first nonlinear optical element 11 to control the wavelengths of the light in the first signal pulses and first idler pulses. The wavelength control system 15 is also preferably configured to control a property of the second nonlinear optical element 12 to control the wavelengths of the light in the second signal pulses and second idler pulses. However, only one of the first and second nonlinear optical elements 11, 12 may be controllable in this way.

The wavelength control system 15 may operate under control of the apparatus control system 6.

In some examples, the wavelength control system 15 is configured to control the temperature of one or both of the nonlinear optical elements 11, 12. In this instance, one or both of the nonlinear optical elements 11, 12 is housed in an oven, the temperature of which can be controlled.

In some examples, one or both of the nonlinear optical elements 11, 12 have a grating with a period that varies in a direction perpendicular to the path of the pump pulses. The wavelength control system 15 is configured to control a position of one or both of the nonlinear optical elements 11, 12 relative to the path of the pump pulses, thereby controlling the grating period through which the pump pulses propagate. This can enable the first and second wavelengths to be changed rapidly (e.g. at a rate of ˜1 nanometre per second or more), which can be particularly useful for applications such as, for example, CARS spectroscopy/microscopy.

In some examples, the wavelength control system 15 is configured to controllably rotate each of the nonlinear optical elements 11, 12 to control an angle of incidence of the pump pulses on the on each of the nonlinear optical elements 11, 12.

In some examples, more than one of the abovedescribed means for controlling the first and second wavelengths may be used. Other suitable means for controlling the first and second wavelengths may also be used.

—Avoidance of Coherent Coupling—

The oscillator 3 is configured to substantially or completely avoid coherent coupling between the first and second resonant pulses for all first wavelengths in a first range and all second wavelengths in a second range which overlaps with the first range. In particular, coherent coupling is substantially or completely avoided even when the light in the first and second resonant (and non-resonant) pulses is degenerate, i.e. has the same wavelength. Moreover, there is no requirement for additional elements in the cavity 10 to achieve this.

The avoidance of coherent coupling is caused by one or preferably both of the following features:

Firstly, because the first and second oscillator subsystems 3a, 3b share the same optical cavity 10, the first and second signal pulses propagate through both of the nonlinear optical elements 11, 12 in each round trip. However, due to the delay line 27, the first and second resonant pulses preferably arrive at different times at each of the nonlinear optical elements 11, 12, thus substantially or completely avoiding coupling therebetween, even when the values of the first and second wavelengths are similar.

Secondly, because the first and second resonant pulses preferably travel in opposite directions around the cavity 10, coherent coupling is substantially or completely avoided even when the first and second wavelengths are similar and even when the first and second resonant pulses arrive at similar times at each of the nonlinear optical elements 11, 12. This may occur because, for example, the delay line 27 has as additional path length of ΔL≈0 or an integral multiple of the cavity length.

—Experimental Results—

Experimental results were obtained for the abovedescribed example of an oscillator 3. In the experiments, each of the nonlinear optical elements 11, 12 was maintained at a fixed position corresponding to a constant grating period Λ=30.5 micrometres. An oven was used to controllably change the temperature of each of the nonlinear optical elements 11, 12 between room temperature and 200° C. with a stability of ±0.1° C.

Properties of the first and second output pulses (hereinafter referred to as the first and second signal output pulses, respectively) and the first and second idler pulses that exit the cavity 10 (hereinafter referred to as the first and second idler output pulses, respectively), were measured. The wavelengths of the first and second signal output pulses are hereinafter referred to as the first and second signal wavelengths, and the wavelengths of the first and second idler output pulses are hereinafter referred to as the first and second idler wavelengths, respectively.

The average power over one or more repetition periods of a set of pulses is hereinafter referred to simply as the power of the pulses. The power of the pump pulses provided to each of the first and second oscillator subsystems 3a, 3b is hereinafter referred to the pump power.

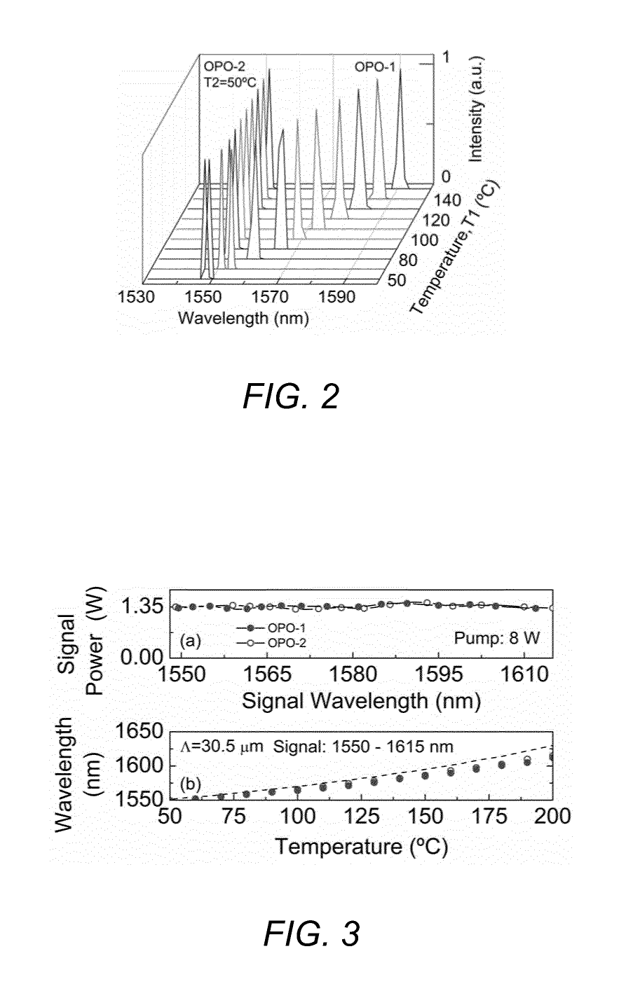

In FIGS. 2 to 5, the first and second oscillator subsystems 3a, 3b are denoted by OPO-1 and OPO-2, respectively.

Wavelengths were measured using a near-infrared spectrometer (Ocean Optics, NIR Quest). Power was measured using a power meter (Melles Griot 13PEM001).

FIG. 2 shows an example of wavelength control by the oscillator 3. By fixing the temperature of the second nonlinear optical element 12 at a temperature T2=50° C., generating a second signal wavelength of 1550 nanometres, and varying the temperature of the first nonlinear optical element 11 from T1=150° C. down to 50° C., the first signal wavelength could be continuously tuned from 1615 to 1551 nanometres, reaching a degenerate point where both of the oscillator subsystems 3a, 3b operate at similar wavelengths. The difference of 1 nanometre between the two signal wavelengths while operating at the same temperature can be attributed to small differences between the ovens housing the MgO:PPLN crystals 11, 12. The results were obtained for a fixed pump power of 8 watts. The cavity 10 is optimized to achieve maximum output powers by alignment and translation of the mirrors 23-1, 23-2, 23-3, 23-4, 24 to achieve the best spatial mode-matching between the resonant signal pulses and the corresponding pump pulses. The temperature T1 of the first nonlinear optical element 11 was also adjusted slightly below 50° C. in order to operate at exact degeneracy, and no coherent coupling or perturbation between the two oscillator subsystems 3a, 3b was observed, even at the degenerate point of 1550 nanometres.

FIG. 3(a) shows the power of the first and second signal output pulses as their wavelengths are varied and as the pump power is held constant at 8 watts. The open circles correspond to power of the first signal output pulses (from the first oscillator subsystem 3a), and the solid circles correspond to the power of the second signal output pulses (from the second oscillator subsystem 3b). The power of the signal output pulses from both of the oscillator subsystems 3a, 3b remains almost constant at 1.35 watts over the range of 1550 to 1615 nanometres.

FIG. 3(b) shows the variation in the first and second signal wavelengths as the temperature of the first and second nonlinear optical elements 11, 12, respectively, is varied. The first and second wavelengths are almost identical in absolute value as well as tuning behaviour. The dashed line corresponds to the theoretically calculated signal wavelength as a function of temperature (T1=T2) for a fixed MgO:PPLN grating period of Λ=30.5 micrometres, using the relevant Sellmeier equations described, for example, in PAUL, O. et al. Temperature-dependent Sellmeier equation in the MIR for the extraordinary refractive index of 5% MgO doped congruent LiNbO₃, Appl. Phys. B, Lasers Opt., 2007, Vol. 86, page 111.

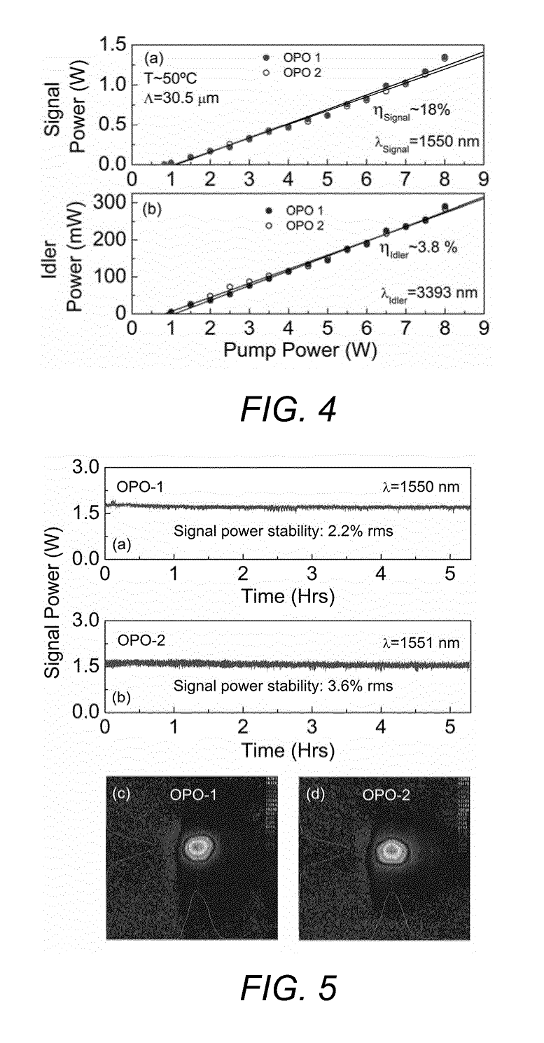

FIG. 4(a) shows the power of the first signal output pulses and the power of the second signal output pulses scaling as a function of the pump power at a constant temperature of T1≈T2≈50° C. In each case, a maximum power of 1.35 watts (at 160 megahertz) was obtained for a maximum pump power of 8 watts (at a repetition rate of 80 megahertz), with a slope efficiency of ˜18%. FIG. 4(b) shows the power of the first idler output pulses and the power of the second idler output pulses scaling as a function of the pump power at a constant temperature of T1≈T2≈50° C. In each case, a maximum power of 290 milliwatts was obtained for the maximum pump power of 8 watts, with a slope efficiency of ˜3.8%. This corresponds to an overall (signal plus idler) extraction efficiency of 44%. There is no evidence of saturation in the power of the output pulses, indicating the possibility of further power scaling by increasing the pump power. Moreover, optimization and fine-adjustment of the output coupling of the signal output pulses can lead to further improvements in the power of the signal output pulses. Both of the oscillator subsystems 3a, 3b have a similar threshold of <830 milliwatts. Although the signal and idler wavelengths are the same in both of the oscillator subsystems 3a, 3b, there is no observable reduction in the threshold, demonstrating the lack of coherent coupling between the oscillator subsystems 3a, 3b.

FIGS. 5(a) and 5(b) show the power stability of the first and second signal output pulses, respectively, over an extended period of time. The first and second oscillator subsystems 3a, 3b exhibit passive output power stabilities of better than 2.2% root-mean-square and 3.6% root-mean-square, respectively, over >5 hours.

FIGS. 5(c) and 5(d) show the spatial beam profiles of the beams from the first and second oscillator subsystems 3a, 3b, respectively. Each of these profiles has a single-peak Gaussian intensity distribution.

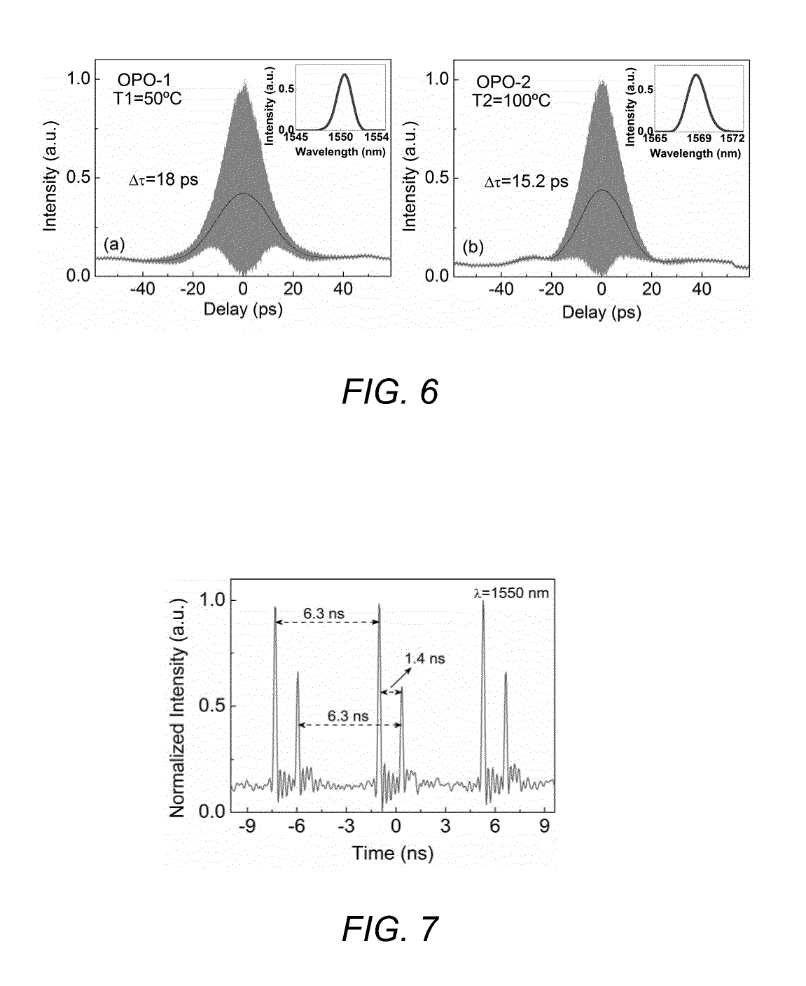

FIGS. 6(a) and 6(b) show the temporal and spectral characteristics of the first and second signal output pulses, respectively, with the first and second nonlinear optical elements 11, 12 at different temperatures of T1=50° C. and T2=100° C., respectively. The temporal characteristics were obtained using an interferometric autocorrelator based on two-photon absorption in a silicon photodetector. The first and second signal output pulses have a Gaussian temporal width of 18 picoseconds and 15.2 picoseconds, respectively. These durations are consistent with the differences in the signal wavelengths and the lengths of the crystals 11, 12. The spectra of the first and second signal output pulses are centred around 1550 nanometres and 1569 nanometres, respectively. Each of the spectra has a smooth, clean profiles with a full-width-at-half-maximum bandwidth of ˜2 nanometres.

FIG. 7 shows the timing of sets of first and second signal output pulses (hereinafter referred to as the first and second signal output pulse trains). The results were obtained using an indium gallium arsenide photodetector (20 gigahertz, 18.5 picoseconds) and a fast oscilloscope (3.5 gigahertz, 40 giga-samples per second). The pulses in each of the first and second signal output pulse trains are separated by 6.3 nanoseconds, corresponding to a repetition frequency of ˜160 megahertz, while the (interleaved) first and second signal output pulse trains are separated by 1.4 nanoseconds. This corresponds to the delay of the second pump pulses relative to the first pump pulses caused by the delay line 27 and the additional path length of ΔL≈42.

Output System

Referring to FIG. 1(a), the output system 4 will now be described in more detail.

The output system 4 is configured to modify properties of the first and/or second output pulses before being provided to the spectroscopy/microscopy system 5.

In some examples, the output system 4 comprises a delay line (not shown) to receive the first or second output pulses. The delay line is preferably configured to synchronise the first and second output pulses, i.e. to compensate for the time offset between the first and second output pulses introduced by the oscillator 3.

In some examples, the output system 4 may be configured to cause the first and second output pulses to propagate in the same direction along a common optical path.

Accordingly, in some examples, the output system 4 may be configured to provide first and second output pulses which overlap spatially and temporally. This can be particularly important for e.g. CARS spectroscopy/microscopy.

Spectroscopy/Microscopy System

Referring to FIG. 1(a), the spectroscopy/microscopy system 5 will now be described in more detail.

The spectroscopy/microscopy system 5 is configured to use the first and second output pulses provided by the oscillator 3.

In some examples, the spectroscopy/microscopy system 5 corresponds to a CARS system. Examples of such systems are described, for example, in EVANS, C. L. et al. Coherent Anti-Stokes Raman Scattering Microscopy: Chemical Imaging for Biology and Medicine, Annual Review Of Analytical Chemistry, 2008, Vol. 1, page 883.

CARS is a third-order nonlinear optical process involving a pump beam of frequency ωₚ, a Stokes beam of frequency ωₛ and a probe beam of frequency ωₚᵣ. These beams interact with a sample and generate a signal at the anti-Stokes frequency (ωₚᵣ+ωₚ−ωₛ). This signal is enhanced if the frequency difference between the pump and the Stokes beams (ωₚ−ωₛ) corresponds to the frequency of a Raman resonance of the sample. Accordingly, CARS can be used to image chemical and biological samples by using molecular vibrations as a contrast mechanism. The first output pulses provided by the oscillator 3 are used as the pump pulses and preferably also as the probe pulses, and the second output pulses provided by the oscillator 3 are used as the Stokes pulses in the CARS process.

In other examples, the spectroscopy/microscopy system 5 may correspond to another type of nonlinear vibrational spectroscopy/microscopy system, for example a stimulated Raman scattering (SRS) spectroscopy/microscopy system.

The spectroscopy/microscopy system 5 may correspond to a time-domain pump-probe spectroscopy/microscopy system. In this instance, the first output pulses may be used as pump pulses to induce a physical effect in a sample (such as absorption or electronic excitation), and the second output pulses may be used as probe pulses to detects a response of the sample. By adjusting the time offset between the probe pulses and the pump pulses, which is preferably achieved using the delay control system 26, the response of the sample can be determined as a function of time.

Apparatus Control System

Referring to FIG. 1(a), the apparatus control system 6 will now be described in more detail.

The apparatus control system 6 is configured to control operation of one or more components of the apparatus, i.e. the pump source 2, the optical parametric oscillator 3, the output system 4 and/or the spectroscopy/microscopy system 5.

For example, where the apparatus 1 is configured to perform CARS spectroscopy/microscopy, the apparatus control system 6 may be configured to cause the oscillator 3 to vary the first and second wavelengths and to cause the spectroscopy/microscopy system 5 to take corresponding readings. Where the apparatus 1 is configured to perform time-domain pump-probe spectroscopy/microscopy, the apparatus control system 6 may be configured to cause the oscillator 3 to vary the time offset between the first and second output pulses and to cause the spectroscopy/microscopy system 5 to take corresponding readings.

The apparatus control system 6 may correspond to a suitably programmed computer.

Terahertz Source

The oscillator 3 may be used as part of apparatus (not shown) to provide pulses comprising terahertz radiation of a controllable wavelength. Such an apparatus (hereinafter referred to as a terahertz source) includes a pump source 2 and an oscillator 3 substantially as described above. The terahertz source also includes a third nonlinear optical element configured to mix the first and second output pulses to provide pulses (hereinafter referred to as terahertz pulses) comprising radiation of a terahertz frequency corresponding to the difference between frequencies corresponding to the first and second wavelengths. Accordingly, by controlling the first and second wavelengths and the difference therebetween, the frequency of the radiation in the terahertz pulses can be controlled. For example, a difference of ˜5 nanometres between the first and second wavelengths corresponds to a terahertz frequency of ˜1.5 terahertz and a corresponding wavelength of ˜200 micrometres. The smaller the difference between the first and second wavelengths, the longer the wavelength of the radiation in the terahertz pulses.

In some examples, the first and second output pulses from the oscillator 3 may be provided to the third nonlinear optical element, preferably via an output system 4 as described above to synchronise the first and second output pulses.

In some examples, the third nonlinear optical element may be contained in the cavity. In this instance, the oscillator is configured such that the first and second resonant pulses propagate in the same direction around the cavity, and such that the first and second resonant pulses propagate through the third nonlinear optical element at the same time. The cavity may correspond to a bow-tie cavity formed from four plano-concave mirrors. The cavity may also include a parabolic mirror with a central hole to allow passage of the beams other than the terahertz beam, but which reflects the majority of the highly divergent terahertz radiation out of the cavity. The high intensity of the first and second resonant pulses inside the cavity can increase efficiency and output power of the terahertz source.

Advantages of the Oscillator

Some of the advantages of the oscillator 3 will now be described in more detail.

Firstly, the wavelength of the first and second output pulses can be independently and arbitrarily controlled, over a wide range of frequencies including through degeneracy without significant coherent coupling therebetween.

For spectroscopy, e.g. CARS spectroscopy, this can enable measurements of a wide range of frequencies, e.g. Raman frequencies, and hence a wide range of chemical or biological matter.

For a terahertz source, this can enable output pulses with more closely spaced wavelengths and hence terahertz radiation with longer wavelengths to be stably provided. Thus, the terahertz tuning range can be extended.

Secondly, the time offset between the first and second output pulses can be readily and/or precisely controlled by the input system 14 of the oscillator 3. The time offset between (or the synchronisation of) the first and second output pulses is inherently optical controlled and so can be more precisely controlled than, for example, an arrangement in which pulses from different pump sources are electronically synchronised.

For time-domain pump-probe spectroscopy/microscopy, this can be particularly important.

For a terahertz source, precise control of the time offset between initial first and second pump pulses can facilitate good synchronisation between final first and second pump pulses and hence increased efficiency and output power.

Thirdly, the properties of the first output pulses can be more uniform with the properties of the second output pulses. This is compared, for example, with an arrangement including two optical parametric oscillators. For example, the time offset between corresponding ones of the first and second output pulses can be more uniform, i.e. the timing jitter can be less (e.g. <1 picosecond), the powers of the first and second output pulses can be more uniform/stable (e.g. <2% root mean square), the wavelengths of the first and second output pulses can be more uniform/stable (e.g. <0.5 nanometres), the pulse durations of the first and second output pulses can be more uniform/stable (e.g. <1 picosecond), etc. This is because the first and second sets of output pulses originate from a single cavity 10 with a common mechanical structure and in which the resonant pulses propagate along a common optical path. Any environmental, mechanical or thermal perturbations etc. will be common to both sets of output pulses.

For spectroscopy, this increased uniformity can enable more accurate measurements to be performed. For example, less timing jitter can be particularly important for time-domain pump-probe spectroscopy/microscopy. More uniform first and second wavelengths can be particularly important for CARS and other types spectroscopy, which are responsive to wavelength differences.

For a terahertz source, less timing jitter can enable the power of the terahertz radiation produced to be more stable, while more uniformity/stability in the other properties of the first and second output pulses can provide similar advantages in the corresponding properties of the terahertz pulses.

Fourthly, having a single cavity 10 can also make the oscillator 3 more compact and/or more cost-efficient to manufacture.

Modifications

It will be appreciated that many other modifications may be made to the embodiments hereinbefore described.

1. An optical parametric oscillator configured to provide first ultrashort output pulses comprising light of a first wavelength and second ultrashort output pulses comprising light of a second wavelength, wherein at least one of the first and second wavelengths is independently controllable, the optical parametric oscillator comprising:
an optical resonator containing first and second nonlinear optical elements and comprising an output coupler;
an input system configured to provide first pump pulses to the first nonlinear optical element and second pump pulses to the second nonlinear optical element; and
a control system;
wherein the first nonlinear optical element is configured to provide first signal pulses and first idler pulses in response to the first pump pulses, the first signal pulses or the first idler pulses corresponding to first resonant pulses comprising light of the first wavelength;
wherein the second nonlinear optical element is configured to provide second signal pulses and second idler pulses in response to the second pump pulses, the second signal pulses or the second idler pulses corresponding to second resonant pulses comprising light of the second wavelength;
wherein the output coupler is configured to couple light from the first resonant pulses to the first output pulses and light from the second resonant pulses to the second output pulses;
wherein the control system is configured to control a property of the first nonlinear optical element to control the first wavelength and/or a property of the second nonlinear optical element to control the second wavelength; and
wherein the optical parametric oscillator is configured to substantially or completely avoid coherent coupling between the first and second resonant pulses for all first wavelengths in a first range and all second wavelengths in a second range which overlaps with the first range.

2. An optical parametric oscillator according to claim 1, configured such that the first and second resonant pulses propagate in opposite directions around the optical resonator.

3. An optical parametric oscillator according to claim 2, wherein the input system is configured to provide the first pump pulses such that the first pump pulses propagate along a part of a path around the optical resonator in a first direction relative to the path, and configured to provide the second pump pulses such that the second pump pulses propagate along a part of the path around the optical resonator in a second, opposite direction relative to the path.

4. An optical parametric oscillator according to claim 2, configured to provide the first and second output pulses in different directions.

5. An optical parametric oscillator according to claim 1, configured such that the first and second resonant pulses propagate in the same direction around the optical resonator, and configured to provide the first and second output pulses in the same direction.

6. An optical parametric oscillator according to claim 1, configured such that the first and second resonant pulses propagate through the first nonlinear optical element at different times and propagate through the second nonlinear optical element at different times.

7. An optical parametric oscillator according to claim 6, configured to provide the first pump pulses to the first nonlinear optical element and the second pump pulses to the second nonlinear optical element at different times.

8. An optical parametric oscillator according to claim 1, comprising an element to provide a first and a second pump pulse in response to a pulse originating from a pump source, optionally wherein the element comprises a polarising beam splitter.

9. An optical parametric oscillator according to claim 8, configured to delay the first pump pulses or the second pump pulses, optionally configured to controllable delay the first pump pulses or the second pump pulses such that a time offset between the first and second output pulses is controllable.

10. An optical parametric oscillator according to claim 9, comprising a delay line to delay the first pump pulses or the second pump pulses.

11. An optical parametric oscillator according to claim 1, wherein the first and second pump pulses have the same repetition frequency, the first and second resonant pulses have the same round-trip frequency, and the repetition frequency corresponds to the round-trip frequency such that the first and second nonlinear optical elements are synchronously pumped.

12. An optical parametric oscillator according to claim 1, configured to provide output pulses corresponding to the first signal pulses, the first idler pulses, the second signal pulses and the second idler pulses.

13. An optical parametric oscillator according to claim 1:
wherein the control system is configured to control the temperature of the first nonlinear optical element to control the first wavelength and/or the temperature of the second nonlinear optical element to control the second wavelength; and/or
wherein the control system is configured to control an angle of incidence of the first pump pulses on the first nonlinear optical element to control the first wavelength and/or an angle of incidence of the second pump pulses on the second nonlinear optical element to control the second wavelength.

14. An optical parametric oscillator according to claim 1, wherein the first nonlinear optical element comprises a grating with a period which varies in a direction perpendicular to a path of the first pump pulses and the control system is configured to control a position of the first nonlinear optical element relative to the path of the first pump pulses to control the first wavelength and/or wherein the second nonlinear optical element comprises a grating with a period which varies in a direction perpendicular to a path of the second pump pulses and the control system is configured to control a position of the second nonlinear optical element relative to the path of the second pump pulses to control the second wavelength.

15. An optical parametric oscillator according to claim 1:
wherein each of the first and second output pulses has a duration of more than 1 picosecond and/or less than 1 nanosecond; and/or
wherein the first and/or second range extends over at least 65 nanometres; and/or
wherein the first or second output pulses have an average power of at least 1.5 watts; and/or
having a total power extraction efficiency of at least 44%; and/or
having a passive power stability of better than 3.6% over at least 5 hours; and/or
wherein, for a constant input power, the output pulses have a substantially constant average power for all first wavelengths in the first range and all second wavelengths in the second range; and/or
wherein the light in an output pulse has a full width at half maximum bandwidth of no more than 2 nanometres.

16. Apparatus comprising:
a mode-locked pump source; and
an optical parametric oscillator according to claim 1, comprising an element to provide the first and second pump pulses in response to pulses originating from the pump source.

17. Apparatus comprising:
an optical parametric oscillator according to claim 1; and
a spectroscopy system configured to use the first and second output pulses;
optionally wherein the spectroscopy system corresponds to:
a nonlinear vibrational spectroscopy system, or
a coherent anti-Stokes Raman scattering system in which the first output pulses are used as pump pulses and the second output pulses are used as a Stokes pulses, or
a stimulated Raman scattering system in which the first output pulses are used as pump pulses and the second output pulses are used as a Stokes pulses, or
a time-domain pump-probe spectroscopy system in which the first output pulses are used as pump pulses and the second output pulses are used as probe pulses.

18. Apparatus configured to provide pulses comprising light of a controllable terahertz frequency, the apparatus comprising:
an optical parametric oscillator according to claim 1; and
a third nonlinear optical element configured to mix a first output pulse and a second output pulse to provide a pulse comprising light of the terahertz frequency corresponding to the difference between frequencies corresponding to the first and second wavelengths.

19. Apparatus according to claim 17, comprising:
a delay line to receive the first or second output pulses and to synchronise the first and second output pulses.

20. Apparatus configured to provide pulses comprising light of a controllable terahertz frequency, the apparatus comprising:
an optical parametric oscillator according to claim 1; and
a third nonlinear optical element contained in the optical resonator and configured to mix a first resonant pulse and a second resonant pulse to provide a pulse comprising light of the terahertz frequency corresponding to the difference between frequencies corresponding to the first and second wavelengths;
wherein the output coupler is an output for the light of the terahertz frequency.
